(19) United States
(12) Patent Application Publication
(10) Pub. No.: US 2024/0159970 A1
(43) Pub. Date: May 16, 2024

(54) OPTICAL WAVEGUIDE ELEMENT, AND OPTICAL MODULATION DEVICE AND OPTICAL TRANSMISSION DEVICE WHICH USE SAME

(71) Applicant: SUMITOMO OSAKA CEMENT CO., LTD., Tokyo (JP)

(72) Inventors: Takeshi SAKAI, Tokyo (JP); Toshio KATAOKA, Tokyo (JP); Yu KATAOKA, Tokyo (JP)

(73) Assignee: SUMITOMO OSAKA CEMENT CO., LTD., Tokyo (JP)

(21) Appl. No.: 18/284,498

(22) PCT Filed: Mar. 30, 2022
(86) PCT No.: PCT/JP2022/015882

§ 371 Date: Sep. 27, 2023

(30) Foreign Application Priority Data
Mar. 31, 2021 (JP) 2021-059222

(51) Int. Cl. G02B 6/34; G02B 6/30

(52) U.S. Cl. CPC G02B 6/34; G02B 6/30

(57) ABSTRACT

An optical waveguide device that enables a location in which an optical loss such as a propagation loss or a coupling loss occurs to be easily specified is provided. An optical waveguide device includes a substrate 1 on which an optical waveguide 2 is formed, and a grating 6 formed in a part of the optical waveguide 2 or a grating 6 connected to a monitoring optical waveguide 5 that merges with or branches from a part of the optical waveguide 2, in which inputting a light wave into the optical waveguide or outputting at least a part of the light wave propagating through the optical waveguide is performed through the grating 6.

### TECHNICAL FIELD

The present invention relates to an optical waveguide device, and an optical modulation device and an optical transmission apparatus using the same, and particularly to an optical waveguide device including a substrate on which an optical waveguide is formed.

### BACKGROUND ART

In the field of optical communication or in the field of optical measurement, optical waveguide devices such as an optical modulator that is obtained by forming an optical waveguide on a substrate of lithium niobate (LN) or the like having an electro-optic effect and that is provided with a modulation electrode which modulates a light wave propagating through the optical waveguide have been widely used.

In recent optical modulation devices such as a high bandwidth-coherent driver modulator (HB-CDM), it has been required to incorporate a driver circuit that drives the optical waveguide device into a case together with the optical waveguide device and furthermore, to reduce a size of the entire package. In the case of disposing the driver circuit on one end side of the optical waveguide device and of inputting a high-frequency signal into the optical waveguide device, it has been suggested to dispose an input port for inputting the light wave and an output port for outputting the light wave together on an other end side of the optical waveguide device.

In order to dispose the optical input and the optical output at the same end of the substrate, it is required to form a folded optical waveguide as shown in Patent Literature No. 1. In the optical modulator using LN in the related art, a width of the formed optical waveguide is approximately 10 μm, which is the same as a core diameter of an optical fiber. Thus, in a case where the optical waveguide having a width of 10 μm is folded, it is difficult to reduce a size of the substrate. In addition, a problem arises in that a propagation loss in a U-turn waveguide is increased.

In order to eliminate this problem, an optical waveguide device in which the width of the optical waveguide is narrowed to approximately 1 μm has been suggested. However, there is a significant difference in a mode field diameter (MFD) of the propagating light wave in connecting the optical waveguide device to the optical fiber. Thus, in a case where the optical waveguide device is simply connected to the optical fiber, a connection loss is also increased. Thus, it has also been suggested to provide a spot size converter (SSC) that changes the MFD in the input port and the output port of the optical waveguide of the optical waveguide device.

FIG. 1 is an example of the optical waveguide device used in the HB-CDM, in which a folded optical waveguide 2 is provided in the substrate 1 and furthermore, the SSC (the SSC of the input port is denoted by reference sign 3) is provided in the input port and the output port of the optical waveguide. Lin is input light that is input through the optical fiber. In addition, light waves output from two output ports are input into the optical fiber through a polarization-combining part 4 as output light Lout. A shape of the optical waveguide is not only simply folded but also is complicated such that a plurality of Mach-Zehnder type optical waveguides are disposed in a nested form (nest type).

In FIG. 1, the light wave sequentially propagates through a plurality of constituents in an order of the SSC 3 of the input port, the optical waveguide 2 (Mach-Zehnder type optical waveguides), the SSC of the output port, and an output optical fiber from an input optical fiber. In a case where an overall propagation loss of the optical modulator is large, a problem arises in that which location is problematic cannot be easily specified because the light wave propagates through many different locations.

In addition, in the case of forming the SSC to gradually increase the width of the optical waveguide, the SSC is formed at the same time as when the optical waveguide is formed, and the optical waveguide can be easily inspected (evaluated). However, in the case of forming the SSC by, for example, adding another material after forming the optical waveguide, it is difficult to input or output light having a small MFD into or from the optical waveguide when the optical waveguide is formed. Thus, it is not easy to inspect (evaluate) the optical waveguide.

In addition, while a configuration of forming a mirror on a part of the substrate to reflect the light wave is considered, a numerical aperture (NA) is increased in a case where the MFD is small. Thus, reflecting the entire light wave requires forming a sufficiently large mirror having high surface accuracy on the substrate, which is not realistic.

### CITATION LIST

### Patent Literature

[Patent Literature No. 1] Japanese Laid-open Patent

Publication No. 2020-134874

[Patent Literature No. 2] International Publication No. WO2012/042708

### SUMMARY OF INVENTION

### Technical Problem

An object to be solved by the present invention is to solve the above problem and to provide an optical waveguide device that enables a location in which an optical loss such as a propagation loss or a coupling loss occurs to be easily specified. In addition, an optical modulation device and an optical transmission apparatus using the optical waveguide device are provided.

### Solution to Problem

In order to solve the object, an optical waveguide device, an optical modulation device, and an optical transmission apparatus of the present invention have the following technical features.

(1) An optical waveguide device includes a substrate on which an optical waveguide is formed, and a grating formed in a part of the optical waveguide or a grating connected to a monitoring optical waveguide that merges with or branches from a part of the optical waveguide, in which inputting a light wave into the optical waveguide or outputting at least a part of the light wave propagating through the optical waveguide is performed through the grating.

(2) In the optical waveguide device according to (1), the optical waveguide includes a Mach-Zehnder type optical waveguide, and inputting the light wave into an input port of the Mach-Zehnder type optical waveguide or outputting at least a part of the light wave from an output port of the Mach-Zehnder type optical waveguide is performed through the grating.

(3) In the optical waveguide device according to (1) or (2), the optical waveguide is a rib type optical waveguide.

(4) In the optical waveguide device according to any one of (1) to (3), a spot size converter that changes a mode field diameter of the light wave is provided in an end portion of the optical waveguide.

(5) In the optical waveguide device according to any one of (2) to (4), a light-receiving element is disposed on an upper surface side of the grating through which at least a part of the light wave propagating through the optical waveguide is output.

(6) In the optical waveguide device according to (5), an optical absorption member that absorbs the light wave which is output from the grating and which is not input into the light-receiving element is provided.

(7) In the optical waveguide device according to any one of (1) to (6), an optical absorption member is disposed on a side opposite to a side on which the monitoring optical waveguide is disposed with respect to the grating connected to the monitoring optical waveguide.

(8) In the optical waveguide device according to any one of (1) to (7), a branching part and a multiplexing part of the optical waveguide and an optical path of an optical component disposed outside the substrate are not disposed on a line extending in a traveling direction of the light wave propagating from the monitoring optical waveguide to the grating.

(9) In the optical waveguide device according to any one of (1) to (8), a reinforcing member is disposed on a part of an upper surface of the substrate, and the grating is formed at a position at which the reinforcing member is not disposed.

(10) An optical modulation device includes the optical waveguide device according to any one of (1) to (9), a case accommodating the optical waveguide device, and an optical fiber through which a light wave is input into the optical waveguide device or output from the optical waveguide device.

(11) In the optical modulation device according to (10), a modulation electrode that modulates the light wave propagating through the optical waveguide is provided in the substrate, and an electronic circuit that amplifies a modulation signal to be input into the modulation electrode is provided inside or outside the case.

(12) An optical transmission apparatus includes the optical modulation device according to (11), and an electronic circuit that outputs a modulation signal causing the optical modulation device to perform a modulation operation.

### Advantageous Effects of Invention

In the present invention, an optical waveguide device is configured to include a substrate on which an optical waveguide is formed, and a grating formed in a part of the optical waveguide or a grating connected to a monitoring optical waveguide that merges with or branches from a part of the optical waveguide, in which inputting a light wave into the optical waveguide or outputting at least a part of the light wave propagating through the optical waveguide is performed through the grating. Thus, inputting the light wave into a specific optical waveguide through the grating or deriving a part of the light wave propagating through the specific optical waveguide through the grating can be simply performed. Accordingly, an optical loss in a specific location of the optical waveguide device can be easily inspected.

### BRIEF DESCRIPTION OF DRAWINGS

FIG. 1 is a plan view illustrating an example of an optical waveguide device in the related art.

FIG. 2 is a plan view illustrating a first example of an optical waveguide device according to the present invention.

FIG. 3 is a side view for describing an optical waveguide and a grating in the optical waveguide device in FIG. 2.

FIG. 4 is a plan view illustrating a second example of the optical waveguide device according to the present invention.

FIG. 5 is a side view for describing a monitoring optical waveguide and a grating used in the optical waveguide device in FIG. 4.

FIG. 6 is a plan view for describing the monitoring optical waveguide and the grating used in the optical waveguide device in FIG. 4.

FIG. 7 is a side view for describing a state where a light-receiving element is disposed on an upper side of the grating.

FIG. 8 is a plan view for describing a method of inspection using an input port of a light wave of the optical waveguide device.

FIG. 9 is a plan view for describing a method of inspection using an output port of the light wave of the optical waveguide device.

FIG. 10 is a plan view for describing another inspection method of the optical waveguide device according to the present invention.

FIG. 11 is a plan view for describing a state where an optical absorption member (an electrode or the like) is disposed on a rear stage of the grating.

FIG. 12 is a plan view illustrating an optical modulation device and an optical transmission apparatus according to the present invention.

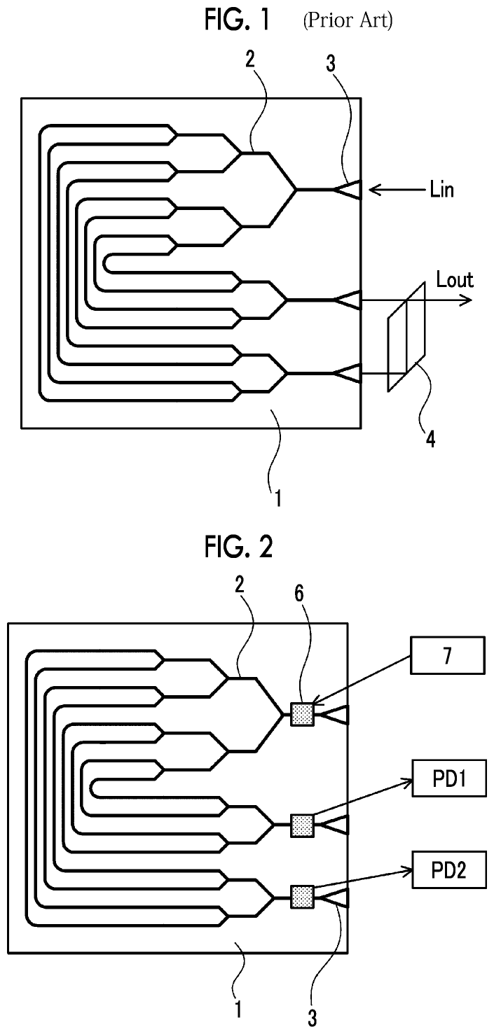

### DESCRIPTION OF EMBODIMENTS

Hereinafter, the present invention will be described in detail using preferred examples.

In the present invention, as illustrated in FIGS. 2 to 6, an optical waveguide device includes a substrate 1 on which an optical waveguide 2 is formed, and a grating 6 formed in a part of the optical waveguide 2 or a grating 6 connected to a monitoring optical waveguide 5 that merges with or branches from a part of the optical waveguide 2, in which inputting a light wave into the optical waveguide or outputting at least a part of the light wave propagating through the optical waveguide is performed through the grating 6.

As the substrate 1 having an electro-optic effect, a substrate of lithium niobate (LN), lithium tantalate (LT), lead lanthanum zirconate titanate (PLZT), or the like, a vapor-phase growth film formed of these materials, a composite substrate obtained by joining these materials to different types of substrates, or the like can be used.

In addition, various materials such as semiconductor materials or organic materials can also be used.

As a method of forming the optical waveguide, it is possible to use a rib type optical waveguide in which a part of the substrate corresponding to the optical waveguide has a protruding shape by, for example, etching a substrate surface other than the optical waveguide or by forming grooves on both sides of the optical waveguide. In addition, it is also possible to form the optical waveguide by forming a high-refractive index part on the substrate surface with Ti or the like using a thermal diffusion method, a proton exchange method, or the like. It is also possible to form a composite optical waveguide by, for example, diffusing a high-refractive index material in the rib type optical waveguide part.

The substrate on which the optical waveguide is formed is formed as a thin plate by polishing to have a thickness of 10 μm or lower, more preferably 5 μm or lower, and still more preferably lower than 1 μm (a lower limit of the thickness may be 0.3 μm or higher) in order to achieve velocity matching between a microwave of a modulation signal and the light wave. A height of the rib type optical waveguide may be set to 1 μm or lower. In addition, it is possible to form a vapor-phase growth film having a thickness of approximately that of the substrate on a holding substrate and to process the film into a shape of the optical waveguide.

The substrate (a thin plate or a thin film) on which the optical waveguide is formed is adhesively fixed to the holding substrate via direct joining or through an adhesive layer of resin or the like in order to increase mechanical strength. As the holding substrate to be directly joined, a material such as quartz that has a lower refractive index than the optical waveguide and than the substrate on which the optical waveguide is formed and that has a similar coefficient of thermal expansion to the optical waveguide or the like is preferably used. In addition, in joining to the holding substrate through an intermediate layer having a low refractive index, it is possible to use the same material as the substrate on which the optical waveguide is formed, for example, an LN substrate, as a reinforcing substrate or to use a substrate of silicon or the like having a high refractive index as the holding substrate.

In a case where the optical waveguide device is used as an optical modulator, a modulation electrode is disposed along the optical waveguide, particularly branched waveguides of Mach-Zehnder type optical waveguides. In addition, in the optical waveguide device of the present invention, a spot size converter (SSC) 3 that changes an MFD of the light wave may be disposed as in Patent Literature No. 2 or the like. Particularly, even in the case of using an optical waveguide having a small MFD, such as in the case of forming the SSC by, for example, adding another material after forming the optical waveguide, using the grating described later makes it possible to easily inspect the optical waveguide without requiring a mirror having high surface accuracy.

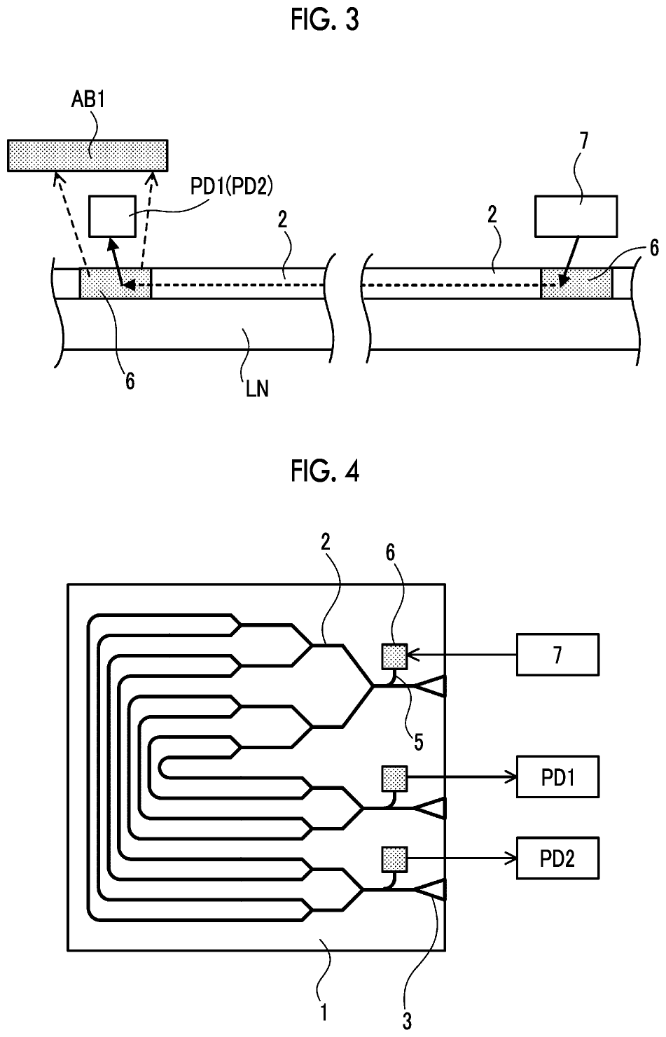

As illustrated in FIGS. 2 and 3, one feature of the optical waveguide device of the present invention is forming the grating 6 in a part of the optical waveguide 2. Inputting the light wave from a light source 7 on an outside into the optical waveguide 2 or outputting a part of the light wave propagating through the optical waveguide 2 to the outside to, for example, receive the light wave via a light-receiving element (PD1, PD2) can be performed through the grating 6. The “optical waveguide” of the present invention also includes a case where the spot size converter (SSC) 3 is formed in a part of the “optical waveguide”. Even in the case of forming the SSC by adding another material after forming the optical waveguide or in the case of forming the SSC by processing the optical waveguide, it is possible to form the grating in a part of the SSC as necessary.

In addition, as illustrated in FIGS. 4 to 6, it is possible to use the monitoring optical waveguide 5 connected to the optical waveguide 2. The monitoring optical waveguide 5 used in the present invention is used for inputting the light wave from a location in the middle of the optical waveguide 2 or for deriving a part of the light wave from a location in the middle of the optical waveguide 2. Merging or branching between the optical waveguide 2 and the monitoring optical waveguide 5 is not limited to a configuration of a merging part or a branching part using a Y-shaped optical waveguide and can use a combining or branching unit such as an optical coupler.

The grating 6 used in the present invention can be configured by forming periodic roughness or a periodic density distribution on a surface of the optical waveguide. In a part corresponding to the grating 6, a width of the optical waveguide can be configured to be widened so that the light wave is easily input or output.

An inspection method using the optical waveguide device in FIG. 2 or 4 will be described. Hereinafter, the example in FIG. 4 will be mainly described. Of course, the same can be applied to the example in FIG. 2. Inspection light from the light source 7 is input into the grating. The inspection light input from the grating is directly input into the optical waveguide 2 or is input into the optical waveguide 2 through the monitoring optical waveguide 5. The inspection light that has passed through a plurality of Mach-Zehnder type optical waveguides is output to the outside from the grating formed in the optical waveguide 2 or through the monitoring optical waveguide and the grating disposed on an output side and is detected by the light-receiving element (PD1, PD2). In this inspection method, since an optical loss of the optical waveguide 2 can be measured without passing through the SSC 3, a state (characteristic) of the optical waveguide 2 formed on the substrate 1 can be easily determined (evaluated).

In addition, after the state of the optical waveguide 2 is determined, a state of the SSC of the input port and a connection state between an input optical fiber and the input port can be determined by inputting the inspection light into the input port of the optical waveguide device using an optical fiber or the like instead of the light source 7 and by receiving the inspection light using the light-receiving element (PD1, PD2) in FIG. 2 or 4.

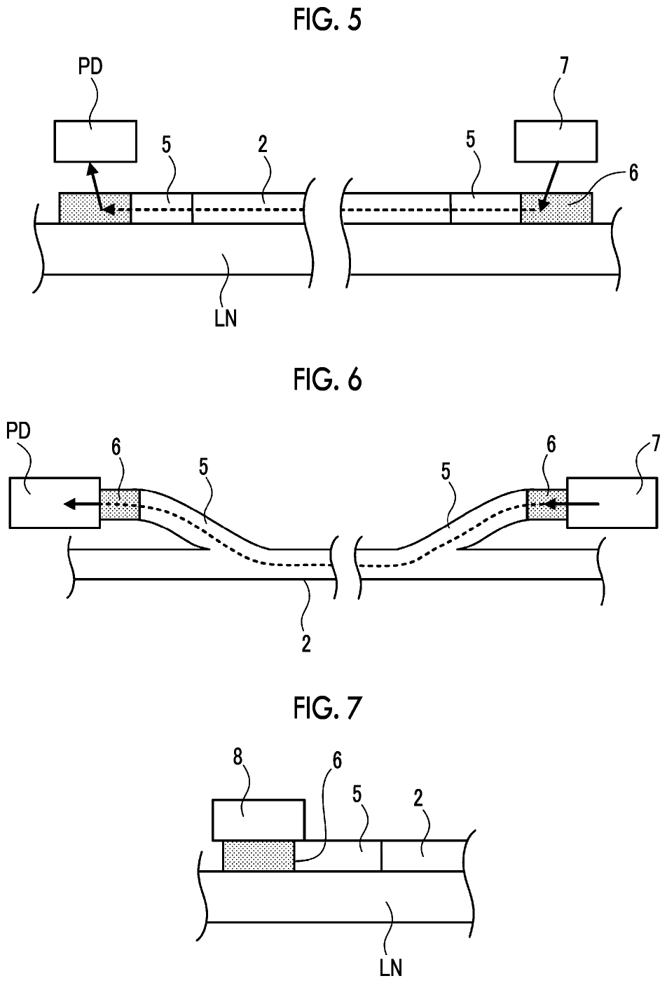

Furthermore, after the state of the optical waveguide 2 is determined, a state of the SSC of the output port and a connection state between an optical system on the output side and the output port can be determined by inputting the inspection light from the light source 7 and by detecting the light wave output from the output port of the optical waveguide device through an optical fiber or through an optical component including polarization combining means. FIG. 5 is a side view and FIG. 6 is a plan view for describing states of the grating 6 and the monitoring optical waveguide 5. The light wave is input into the grating 6 from an upper side of the grating 6 in an inclined direction by the light source 7. On an output side of the grating 6, the light wave input into the grating 6 through the monitoring optical waveguide 5 is radiated to a rear side of the grating 6 in an inclined direction and is detected by the light-receiving element (PD).

The grating in FIG. 4 is not required any more after being used in the inspection. A surface of the grating 6 is covered with an electrode or the like so that the light wave is not input, and leaving the grating 6 and the monitoring optical waveguide 5 for inputting the light wave into the optical waveguide 2 does not particularly pose a problem. However, since the monitoring optical waveguide 5 and the grating 6 that extract a part of the light wave propagating through the optical waveguide 2 always derive a part of the light wave, it is required to effectively use the monitoring optical waveguide 5 and the grating 6. As an example, as illustrated in FIG. 7, it is possible to use the grating 6 for a bias control of the modulation electrode (including a DC bias electrode) by disposing a light-receiving element 8 on an upper side of the grating 6 to monitor the light wave propagating through the optical waveguide 2. Since the grating 6 has a characteristic of radiating the light wave upward, the light wave can be monitored with higher sensitivity than that monitored by detecting evanescent light or the like in the related art.

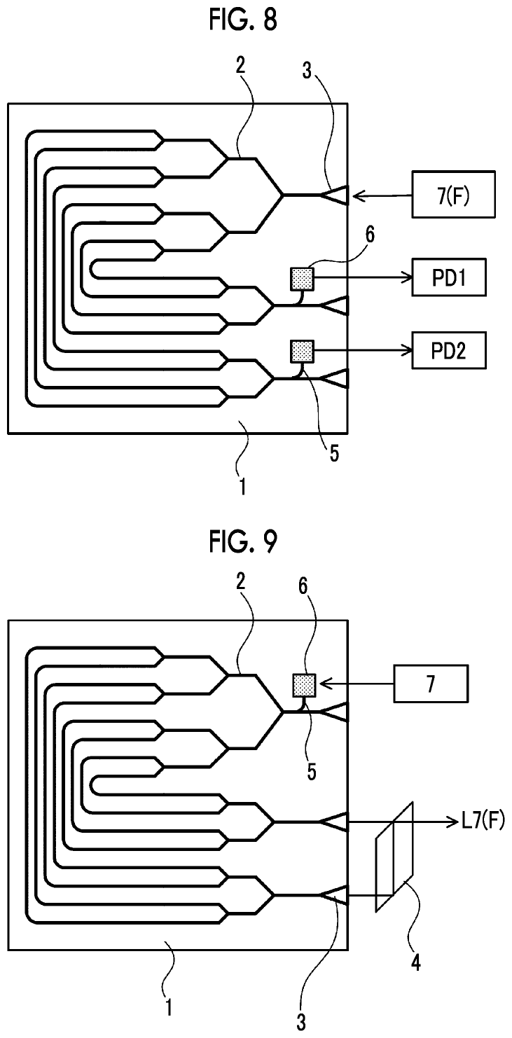

In FIG. 8, the grating 6 and the like on an input side in FIG. 4 are omitted. Optical characteristics such as optical losses of the SSC 3 and the optical waveguide 2 on the input side can be measured at the same time by inputting input light of the optical fiber or the like into the input port (SSC 3) of the optical waveguide device as the inspection light. In addition, alignment between the optical fiber on the input side and the input port of the optical waveguide device can be adjusted by receiving and monitoring the inspection light using the light-receiving element (PD1, PD2).

In FIG. 9, the grating 6 and the like on the output side in FIG. 4 are omitted. The optical losses of the optical waveguide 2 and the SSC 3 of the output port can be measured at the same time by inputting the inspection light into the grating 6 from the light source 7 and by detecting output light of the optical waveguide 2 and of the output port (SSC 3) of the optical waveguide device. In addition, alignment between the optical fiber or the optical component on the output side and the output port of the optical waveguide device can be adjusted.

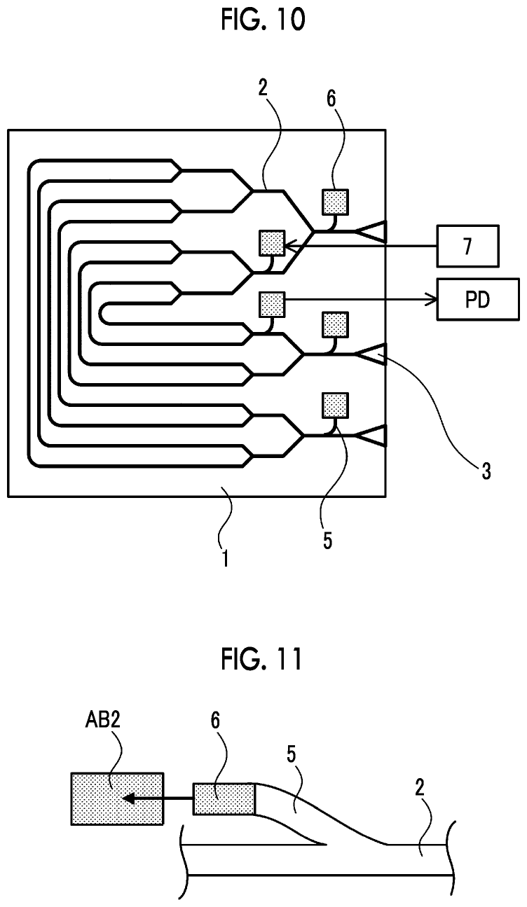

In FIG. 10, the monitoring optical waveguide 5 and the grating 6 are disposed to be connected to an input port or an output port of the Mach-Zehnder type optical waveguides to measure optical losses of not only the input port and the output port of the optical waveguide 2 but also each Mach-Zehnder type optical waveguide. Specifically, FIG. 10 is a configuration in which the plurality of Mach-Zehnder type optical waveguides are disposed in a nested form. The monitoring optical waveguide 5 and the grating 6 are disposed to be connected to an input port, an output port, and the like of a sub-Mach-Zehnder type optical waveguide and also of a main Mach-Zehnder type optical waveguide having the sub-Mach-Zehnder type optical waveguide in each branched waveguide.

The grating and the like disposed in the output port of the Mach-Zehnder type optical waveguide can be used for monitoring a modulation state of the Mach-Zehnder type optical waveguide after the inspection ends, by disposing the light-receiving element to be fixed on an upper side of the grating.

In addition, the monitoring optical waveguide 5 and the grating 6 may be formed in input ports or output ports of other Mach-Zehnder type optical waveguides illustrated in FIG. 10.

While the light wave input into the grating 6 from the monitoring optical waveguide 5 is radiated in an upper rearward direction of the grating 6 by the grating 6, a part of the light wave propagates through the substrate 1 behind the grating 6. Thus, a branching part and a multiplexing part of the optical waveguide 2, and an optical path of an optical component disposed outside the substrate 1 may not be disposed on a line extending in a traveling direction of the light wave propagating from the monitoring optical waveguide 5 to the grating 6. Particularly, in the case of a folded type optical waveguide in which an optical input and an optical output are disposed at the same end of the substrate as in FIG. 10, the input port and the output port of light are significantly close to each other at a distance of, for example, 1500 μm or lower and in some cases, approximately 1000 μm or lower. Thus, such a configuration is particularly preferable. Accordingly, mixing of noise light can be suppressed.

In addition, in order to effectively remove the noise light, for example, as illustrated in FIG. 11, an optical absorption member (AB2) of metal (an electrode or the like) or the like may be disposed on a side opposite to a side on which the monitoring optical waveguide 5 is disposed with respect to the grating 6. Here, the “opposite side” may be, for example, a position at which at least a part of the light wave propagating through the substrate 1 behind the grating 6 is directly or indirectly absorbed.

In addition, in order to absorb high-order diffracted light from the grating that cannot be received by the light-receiving element, and multiple-reflected light resulting from the high-order diffracted light, an optical absorption member (AB1) of metal or the like can be disposed on a rear side of the light-receiving element (PD1) as illustrated in FIG. 3. This technology can also be applied to the optical waveguide device in FIG. 4. In addition, even in a case where the light-receiving element 8 is disposed on the upper side of the grating as illustrated in FIG. 7, the optical absorption member can be disposed on an upper side of the light-receiving element 8. In a case where metal is provided in the optical absorption member, the optical absorption member can be used by connecting to a ground electrode.

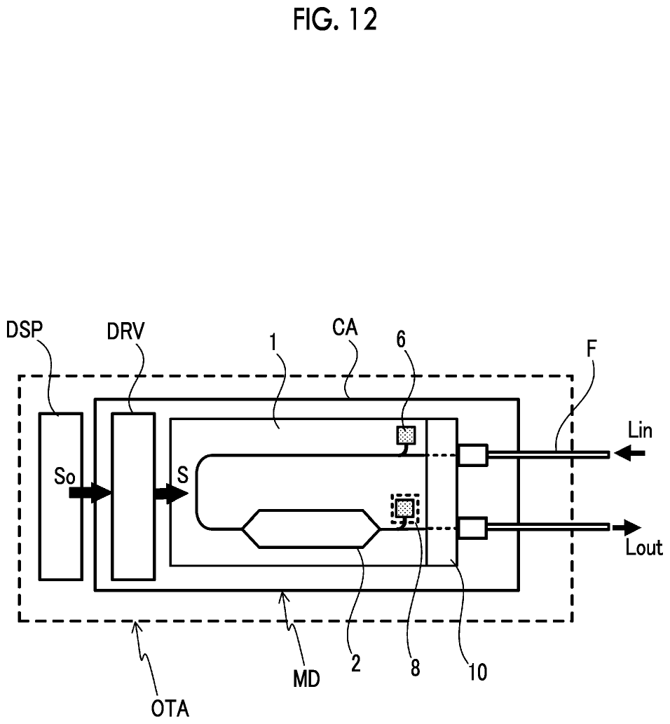

A reinforcing member 10 is disposed in the input port and the output port of the optical waveguide of the substrate 1 to support connection between the optical fiber or the optical component and the substrate 1. In order to avoid interference between the reinforcing member 10 and the grating 6, the grating 6 may be formed at a position at which the reinforcing member 10 is not disposed as illustrated in FIG. 12.

As illustrated in FIG. 12, a compact optical modulation device MD can be provided by accommodating the optical waveguide device (substrate 1) of the present invention inside a case CA of metal or the like and by connecting the optical waveguide device to an outside of the case through an optical fiber F. Of course, the optical fiber can not only be directly connected to the input port or the output port of the optical waveguide of the substrate 1 but also be optically connected through a space optical system.

An optical transmission apparatus OTA can be configured by connecting, to the optical modulation device MD, an electronic circuit (digital signal processor DSP) that outputs a modulation signal S₀ causing the optical modulation device MD to perform a modulation operation. A modulation signal S to be applied to the optical waveguide device is required to be amplified. Thus, a driver circuit DRV is used. The driver circuit DRV and the digital signal processor DSP can be disposed outside the case CA or can be disposed inside the case CA. Particularly, disposing the driver circuit DRV inside the case can further reduce a propagation loss of the modulation signal from the driver circuit.

### INDUSTRIAL APPLICABILITY

As described above, according to the present invention, it is possible to provide an optical waveguide device that enables a location in which an optical loss such as a propagation loss or a coupling loss occurs to be easily specified. In addition, an optical modulation device and an optical transmission apparatus using the optical waveguide device can be provided.

### REFERENCE SIGNS LIST

1: substrate
2: optical waveguide
3: spot size converter (SSC)
5: monitoring optical waveguide
6: grating

1. An optical waveguide device comprising:
a substrate on which an optical waveguide is formed; and
a grating formed in a part of the optical waveguide or a grating connected to a monitoring optical waveguide that merges with or branches from a part of the optical waveguide,
wherein inputting a light wave into the optical waveguide or outputting at least a part of the light wave propagating through the optical waveguide is performed through the grating.

2. The optical waveguide device according to claim 1, wherein the optical waveguide includes a Mach-Zehnder type optical waveguide, and inputting the light wave into an input port of the Mach-Zehnder type optical waveguide or outputting at least a part of the light wave from an output port of the Mach-Zehnder type optical waveguide is performed through the grating.

3. The optical waveguide device according to claim 1, wherein the optical waveguide is a rib type optical waveguide.

4. The optical waveguide device according to claim 1, wherein a spot size converter that changes a mode field diameter of the light wave is provided in an end portion of the optical waveguide.

5. The optical waveguide device according to claim 2, wherein a light-receiving element is disposed on an upper surface side of the grating through which at least a part of the light wave propagating through the optical waveguide is output.

6. The optical waveguide device according to claim 5, wherein an optical absorption member that absorbs the light wave which is output from the grating and which is not input into the light-receiving element is provided.

7. The optical waveguide device according to claim 1, wherein an optical absorption member is disposed on a side opposite to a side on which the monitoring optical waveguide is disposed with respect to the grating connected to the monitoring optical waveguide.

8. The optical waveguide device according to claim 1, wherein a branching part and a multiplexing part of the optical waveguide and an optical path of an optical component disposed outside the substrate are not disposed on a line extending in a traveling direction of the light wave propagating from the monitoring optical waveguide to the grating.

9. The optical waveguide device according to claim 1, wherein a reinforcing member is disposed on a part of an upper surface of the substrate, and the grating is formed at a position at which the reinforcing member is not disposed.

10. An optical modulation device comprising:
the optical waveguide device according to any one of claims 1 to 9;
a case accommodating the optical waveguide device; and
an optical fiber through which a light wave is input into the optical waveguide device or output from the optical waveguide device.

11. The optical modulation device according to claim 10,
wherein a modulation electrode that modulates the light wave propagating through the optical waveguide is provided in the substrate, and
an electronic circuit that amplifies a modulation signal to be input into the modulation electrode is provided inside or outside the case.

12. An optical transmission apparatus comprising:
the optical modulation device according to claim 11; and
an electronic circuit that outputs a modulation signal causing the optical modulation device to perform a modulation operation.
